(19) United States
(12) Patent Application Publication
(10) Pub. No.: US 2026/0124631 A1
(43) Pub. Date: May 7, 2026

(54) Painting System

(71) Applicant: ABB Schweiz AG, Baden (CH)

(72) Inventors: Yngve Finnestad, Sandnes (NO); Jakob Trydal, Kvernaland (NO); Morton Mossige, Nærbø (NO); Bjarne Sandvik, Bryne (NO)

(73) Assignee: ABB Schweiz AG, Baden (CH)

(21) Appl. No.: 19/436,304

(22) Filed: Dec. 30, 2025

Related U.S. Application Data
(63) Continuation of application No. PCT/EP2023/068603, filed on Jul. 5, 2023.

(51) Int. Cl. B05B 13/04; B05B 12/08; B25J 9/16; B25J 11/00; B25J 15/00

(52) U.S. Cl. CPC B05B 13/0431; B05B 12/087; B25J 9/163; B25J 9/1664; B25J 11/0075; B25J 15/0019

(57) ABSTRACT

A painting system includes a paint nozzle dispensing paint onto a surface; an arm moving the paint nozzle over the surface according to an image sweep pattern; a pressurizing device that feeds paint into a paint supply line that extends up to the paint nozzle; and a controller controlling the pressurizing device. The controller is configured with a control law that includes a feedback component for maintaining an output paint pressure of the paint supply line at a setpoint value and further includes a feedforward component which is dependent on image data in a region of a user-defined image, which region is next to be printed according to the image sweep pattern.

### CROSS-REFERENCE TO RELATED APPLICATIONS

The instant application claims priority to International Patent Application No. PCT/EP2023/068603, filed Jul. 5, 2023, which is incorporated herein in its entirety by reference.

### FIELD OF THE DISCLOSURE

The present disclosure generally relates to automated painting using a robot-carried paint nozzle and, more specifically, to controlling a paint supply system in an automated painting system.

### BACKGROUND OF THE INVENTION

FIG. 1A shows an automated painting system 100, in which a paint nozzle 110 is arranged on a movable robot arm 111. The paint nozzle 110 and robot arm 111 are controlled by a robot controller 180 to dispense paint onto a surface 170 in such manner as to form an image thereon. The paint nozzle 110 is supplied with paint from a paint tank 150 through a paint supply line 120. A further controller 140 is arranged to control a pressurizing means 130 so as to maintain an output paint pressure p of the paint supply line at a setpoint value p*.

It is common practice in painting systems of this type to use a feedback loop for controlling the pressure of the paint supply line 120. For example, EP3912822A1 discloses an inkjet printing system where the pressure of the supply line to the inkjet nozzle is controlled in response to a feedback signal which indicates the pressure in the supply line, and which optionally indicates the pressure in a recirculation line. However, it has been observed that similar painting systems sometimes suffer from a slower than desirable control response. The slowness could at worst manifest itself in the form of visible transients (or image artefacts), such as too thin paint coverage in the beginning of a heavily painted image portion or occasional paint leakage after the painted portion ends. While it may be hypothesized that the slow response is caused by control lags or difficult system dynamics, or a combination of these factors, they are in practice difficult to eliminate.

### BRIEF SUMMARY OF THE INVENTION

One objective of the present disclosure is to improve the state-of-the-art type of automated painting systems such that the transients disappear or at least become less visible. It is a further objective to propose improved ways of controlling the output pressure of the paint supply system more stably. In particular, it is an objective to control a pressurizing means in the paint supply system without inconvenient time lags.

In a first aspect of the present disclosure, there is provided a painting system comprising: a paint nozzle configured to dispense paint onto a surface; an arm configured to move the paint nozzle over the surface in accordance with an image sweep pattern; pressurizing means operable to feed paint into a paint supply line which extends up to the paint nozzle; and a controller, which is arranged to control the pressurizing means and configured with a control law that includes a feedback component for maintaining an output paint pressure p of the paint supply line at a setpoint value p*. According to said first aspect, the control law further comprises a feedforward component, which depends on image data in a region which is next to be printed according to the image sweep pattern (i.e., assuming the image sweep pattern is followed), wherein the region is part of a predefined or user-defined image.

The inventors propose to add a feedforward term to the control law, such that the pressurization of the paint supply line is controlled in accordance with a sliding lookahead area into the image that is being printed. The lookahead area follows the predetermined sweep pattern which the paint nozzle follows. The feedforward component may ensure, with proper tuning, a suitable pressure buildup before an episode of high paint flow starts and/or a pressure fadeout when the end of such a high-flow episode approaches. The feedforward component may be described as a predictive component of the control law since it is based on image data from a not yet printed area (lookahead area) of the image, one which will be printed in the near future.

In a second aspect of the present disclosure, there is provided a method of printing a user-defined image onto a surface. The method comprises: dispensing paint from a paint nozzle while the paint nozzle is moved over the surface in accordance with an image sweep pattern; sensing an output paint pressure p of a paint supply line which extends up to the paint nozzle; and feeding a flow of paint into the paint supply line so as to maintain an output paint pressure p of the paint supply line at a setpoint value p*. According to the second aspect, the image printing method further comprises determining, from image data in a region (of the user-defined image) next to be printed according to the image sweep pattern, an adjustment (or compensation) to be applied to said flow of paint.

When a painting system is operated according to this method, because the determined adjustment will react significantly earlier than the actual printing takes place, the output paint pressure will generally have a better stability than in state-of-the-art systems.

The present disclosure further relates to a computer program containing instructions for causing a computer—in particular a controller in a painting system—to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

In the present disclosure, the term “paint nozzle” is used in a broad sense, to cover inter alia arrays (matrices) of nozzles, paint heads and printheads, including inkjet printheads. An “image sweep pattern” may alternatively be described as a robot path.

### BRIEF DESCRIPTION OF THE SEVERAL VIEWS OF THE DRAWING(S)

FIG. 1A is a diagram of a known painting system with a pressure-controlled paint supply line.

FIG. 1B is a diagram of an exemplary paint nozzle adapted for pixel printing that is suitable for use in a painting system in accordance with the disclosure.

FIGS. 2A and 2B are graphs of exemplary feedback control laws, which express the control signal u as a function of observed output paint pressure p, in accordance with the disclosure.

FIGS. 3A, 3B, and 3C are diagrams of exemplary image sweep patterns in accordance with the disclosure.

FIG. 4 is a diagram of a blank image annotated with an image sweep pattern and a region next to be printed in accordance with the disclosure.

FIG. 5 is a user-defined image annotated with regions to be printed that are successive with respect to the image sweep pattern, in accordance with the disclosure.

FIG. 6 is a user-defined image and corresponding plots of a control signal w to the paint nozzle and a paint flow dV/dt in a state-of-the-art painting system in accordance with the disclosure.

FIG. 7 is a user-defined image and corresponding plots of a control signal w to the paint nozzle, a control signal u to the pressurizing device generated according to embodiments herein, and a resulting output paint pressure p, in accordance with the disclosure.

FIG. 8 is a user-defined image annotated with areas where transients may to appear, in accordance with the disclosure.

### DETAILED DESCRIPTION OF THE INVENTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

### System Overview

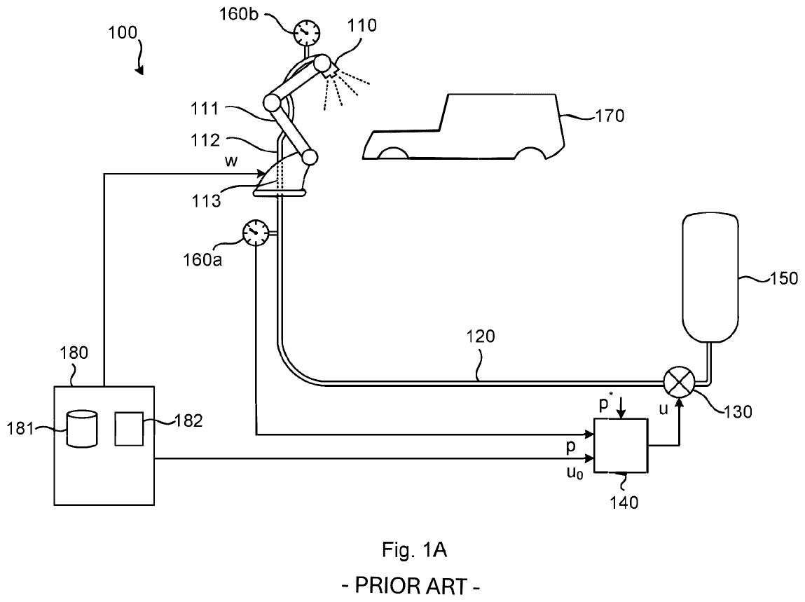

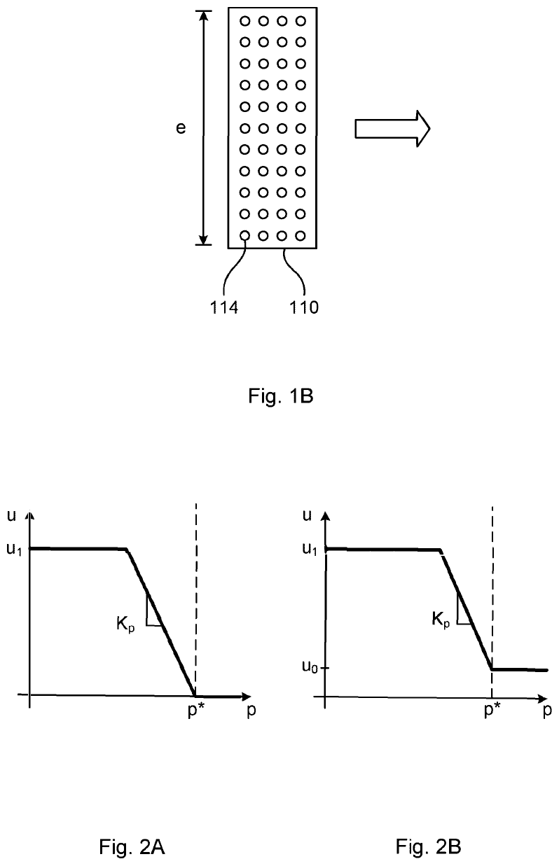

FIG. 1A, which was briefly introduced above, shows an automated painting system 100 with a pressure-controlled paint supply line 120. The automated painting system 100 is adapted (e.g., as regards paint-cell size, arm dimensions) for industrial-scale painting, with an ability to paint surfaces 170 that have a spatial extent of at least 0.1 m, such as at least 0.5 m, such as at least 1.0 m, such as at least several meters, such as at least 10 m. The automated painting system 100 may for example be a vehicle or vessel painting system. In implementations adapted for color image printing, the painting system 100 may include multiple paint supply lines 120 corresponding to different basic colors of paint. The paint supply lines 120 may be operationally independent, or they may share certain hardware components or control functionalities. Conversely, it is envisioned that one paint supply line 120 may be at the service of multiple paint nozzles 110 in a painting system 100.

The arm 111 (or robot arm) may be part of a multi-axis robot with a plurality of segments connected by linear or rotary joints. In the illustrated example, the paint nozzle 110 is arranged at the distal end of the robot arm 111, and it is supplied with paint through internal piping 112, 113 which, for the purposes of the present disclosure, may be considered part of the paint supply line 120. The paint nozzle 110 may be implemented as a one- or two-dimensional array of nozzles, as an applicator, a paint head or a printhead, especially an inkjet printhead.

FIG. 1B shows an example paint nozzle in the form of a printhead 110 adapted for pixel printing, which includes a two-dimensional matrix of individually controllable nozzles 114. The depicted printhead 110 is adapted for movement in the direction indicated by the hollow arrow (when the printhead 110 is oriented as shown in FIG. 1B, this corresponds to the horizontal direction of the drawing), and during such movement it sweeps an image strip that is e units wide. In practice, the width e is usually somewhat less than the outer dimensions of the printhead 110. In a representative pixel-printing use case, the number of individually controllable nozzles 114 may be of the order of one thousand, and the width e of the image strip may be of the order of 0.1 m. The paint density on the surface 170 is generally determined by the ratio of the number of firing nozzles 114 and the speed of movement of the printhead 110 relative to the surface 170. For monochrome printing at constant printhead speed, black color may correspond to all nozzles 114 firing, and a regular grey tone may correspond to half of the number of nozzles 114 firing. Alternatively, the printhead may be configured to fire a constant number of nozzles 114 but to use differently sized droplets to produce the black and grey tones.

The paint nozzle 110 may be designed to eject paint passively, i.e., by force of the pressure in the paint supply line 120 (including the piping 112, 113 in the robot arm 111), in which case it includes one or more controllable valves. Alternatively, the paint nozzle 110 may include active paint ejection means, such as thermal or piezoelectric components or a pump. Either way, a flow of paint from the paint nozzle 110 will normally give rise to a temporary pressure drop at the upstream side, i.e. in the paint supply line 120, especially at the onset of paint flow.

Returning to FIG. 1A, the painting system 100 further includes a robot controller 180 which is arranged to control the paint nozzle 110 and the robot arm 111. More precisely, the robot controller 180 may include processing circuitry 182 which is configured to input image data from a user-defined image stored in memory 181 and to generate a control signal w on that basis, whereby a corresponding image is formed on the surface 170. The user-defined image may have been created by a user (or system owner, or client) or it may have been input by the user from another source; in normal circumstances, the painting system 100 is not expected to visibly alter the image unless this is for reasons of technical necessity. The image data may be represented as monochrome or color (or multi-channel) pixel values, in a raw or compressed data format. The image data may alternatively be represented as machine-level instructions for each nozzle 114 indicating when or where it is to fire; more generally, the image data may be described as a data matrix. Further, the processing circuitry 182 may optionally be configured to perform decoding (or decompression), color-space conversion, resolution conversion (up-sampling, down-sampling, interpolation) etc. so as to adapt the image data to the specifics of the painting system 100 and the surface 170 of the object to be painted. The control signal w may include a first channel wₙ for controlling the paint nozzle 110 and a second channel wₐ for controlling the robot arm 111, that is, conceptually the control signal is a vector w=(wₙ, wₐ). The second channel wₐ may include machine-level commands to actuators in the robot arm 111, or it may be expressed in terms of the desired movements with reference to cartesian coordinate or joint-space coordinates. The second channel wₐ may be a list (script) of such commands to be executed sequentially or at specified points in time.

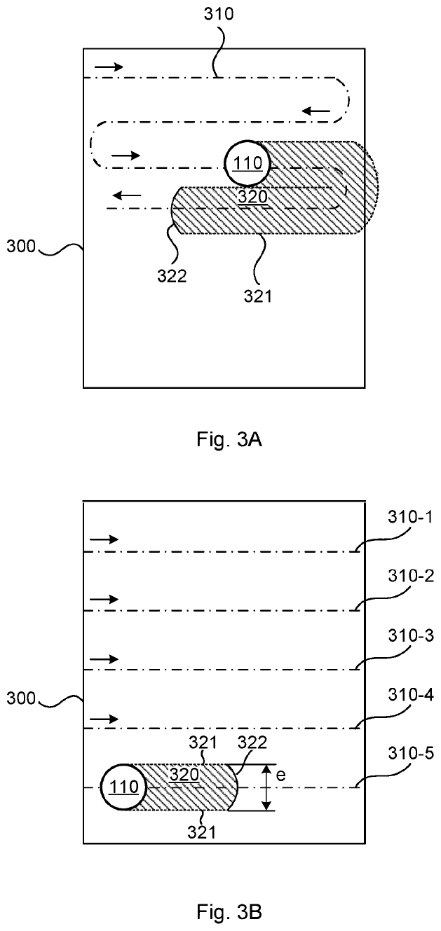

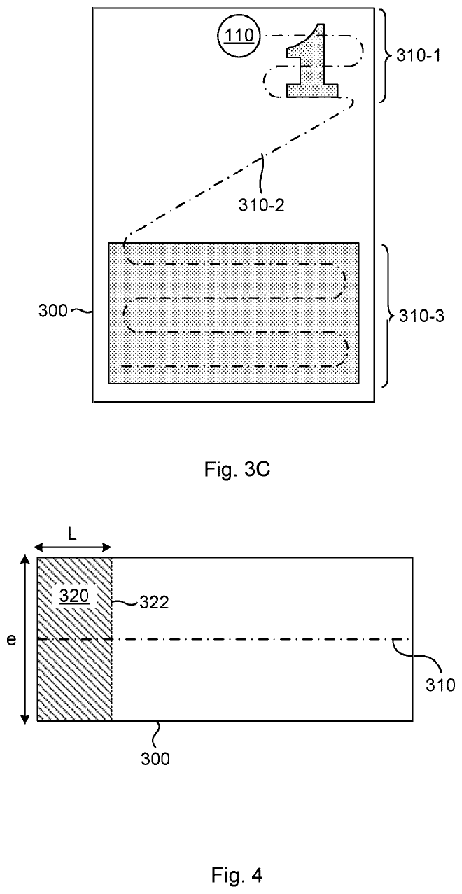

The robot controller 180 may be configured to move robot arm 111 over the surface 170 in accordance with an image sweep pattern while paint is being deposited from the paint nozzle 110. Example image sweep patterns 310 are illustrated in FIG. 3. FIG. 3A shows a continuous image sweep pattern 310 for painting a rectangular image 300 by reciprocating movements of the paint nozzle 110. Two adjacent sweeps may have a spacing corresponding to the width e of the paint nozzle 110, or slightly less to ensure complete coverage of the surface 170. FIG. 3B shows, for the same purpose, a discontinuous image sweep pattern made up of multiple parallel sub-sweeps 310-1, 310-2, . . . interrupted by non-painting movements of the paint nozzle 110. The image sweep pattern may be a static pattern, which is similar for all images and all surfaces 170, or it may have a dynamic dependence. For example, the image sweep pattern may be dynamically adapted in accordance with a three-dimensional shape of the surface 170 (e.g., curvature, orientation). Further, the image sweep pattern may be dynamically adapted in accordance with the image to be printed, wherein empty areas may be left out. This option is illustrated in FIG. 3C, where a first segment 310-1 of the image sweep pattern corresponds to a narrow portion of the image 300 (a figure “1”), a second segment 310-2 of the image sweep pattern corresponds to a non-painting movement of the paint nozzle, and a third segment 310-3 is adapted for a wide portion of the image (a rectangle).

An image sweep pattern 310 may be represented as a two-dimensional curve (e.g., parallel to the surface 170), or as a three-dimensional curve, and it may optionally be associated with a setpoint orientation of the paint nozzle 110 (i.e., towards the surface 170). The image sweep pattern 310 may be associated with a setpoint speed of the paint nozzle 110; the setpoint speed may be constant throughout, or different segments of the image sweep pattern 310 may be associated with different setpoint speed values. As discussed in the applicant's earlier disclosure WO2022058015A1, the actual speed may be monitored during operation by means of sensors in the robot arm 111, wherein the paint flow may be adjusted if the actual speed deviates from the setpoint speed. Similarly, the robot controller 180 may be configured to monitor the progress of executing the different channels of the control signal w, so that the operation of the robot arm 111 and the paint nozzle 110 can be maintained in reasonable mutual synchronicity.

As mentioned, the paint nozzle 110 is supplied with paint from a paint tank 150 through a paint supply line 120. In addition to fresh paint from the tank 150, the paint supply line 120 may be fed, via an optional paint recirculation line (not shown), with overflow paint which is recuperated from a paint cell of the painting system 100 or from the paint nozzle 110. From the tank 150 and any paint recirculation line, a pressurizing means 130 is arranged to feed paint into the paint supply line 120. The pressurizing means 130 may be implemented as a least one pump or compressor arranged to suck paint from the tank 150. Alternatively, the tank 150 may be maintained at elevated pressure during operation, and the pressurizing means 130 may be implemented as a valve which controllably puts the tank 150 in fluid connection with the paint supply line 120, whereby paint flows into the paint supply line 120 in discrete periods. The pressurizing means 130 may optionally have means for evacuating paint from the paint supply line 120 if the pressure is excessive; this may be achieved either by releasing paint back into the tank 150 or into a drain using an overpressure valve, or by actively pumping paint out of the paint supply line 120.

The paint supply line 120 and pressurizing means 130 may form part of a paint supply system, i.e., a subsystem within the automated painting system 100. It may further include a degasser, one or more mechanical filters, and similar per se known components of a paint supply system.

A further controller 140 is arranged to control a pressurizing means 130 so as to maintain an output paint pressure p of the paint supply line 120 at a setpoint value p*. The setpoint value p* may be static, configurable by a user or system owner, or computed dynamically for each image to be printed, e.g., based on an average paint density. The pressurizing means 130 is controllable by means of a control signal u, which may represent a motor current, a motor speed, an open/closed or open/semiopen/closed state of a valve, or the like. Generally speaking, the value of the control signal u is positively correlated with the amount of paint that is fed into the paint supply line 120. The output paint pressure p may be observed by means of a pressure sensor 160a arranged at the paint supply line 120, preferably relatively nearer its distal end. In particular, a sensor 160b arranged at the internal piping 112, 113 in the robot arm may be used instead of, or in addition to, the pressure sensor 160a in the first location.

The controller 140 is configured with a control law, which determines the control signal u as a function of the observed output paint pressure p, that is, u=u(p). In a state-of-the-art painting system 100, the control law includes a feedback component tending to maintain the output paint pressure p at a setpoint value p*.

FIG. 2A is a plot of an example control law in the case where the control signal u is of a numeric datatype, i.e., the control signal u takes values in a discrete, continuous or quasi-continuous numeric range. When the observed output paint pressure p greater than or equal to the setpoint value p*, the pressurizing means 130 is fed with a zero-valued control signal representing no active pressurization. When the observed output paint pressure p sinks below the setpoint value p*, the control signal u to the pressurizing means 130 is gradually increased until it reaches a maximum value u₁ representing the peak feed capacity of the pressurizing means 130. In some implementations, the control signal increase is proportional to the pressure decrease in accordance with a first control gain Kₚ>0:

$$du = - {K}_{p} dp .$$

The first control gain Kₚ may be tuned to provide a steepness suitable for the system dynamics, that is, to strike a desired balance between responsiveness and stability. The feedback control law plotted in FIG. 2A, representing a proportional (P) regulator, may be summarized as

$${u}_{FB} ( p ) = \{ \begin{matrix}{u}_{1} , & p \leq {p}_{1} , \\ {K}_{p} \times ( {p}^{*} - p ) , & {p}_{1} < p < {p}^{*} , \\ 0 , & {p}^{*} \leq p ,\end{matrix}$$

where p₁=p*−u₁/Kₚ. In steady-state operation, the operating pressure of the paint supply line 120 may be somewhat below the setpoint value p*, so that the pressurizing means 130 is active feeding new paint into the paint supply line 120 at approximately the same rate as the paint is being ejected from the paint nozzle 110.

The present disclosure further covers painting systems 100 where the controller 140 is configured as proportional-integral (PI) regulator or a proportional-integral-derivative (PID) regulator. With reference to a PI regulator, for example, the control signal may be written as a function of time as follows:

$${u}_{PI} ( t ) = - {K}_{p , P} \times ( p ( t ) - {p}^{*} ) - {K}_{p , I} {\int }_{0}^{t} ( p ( t ) - {p}^{*} ) dt ,$$

where K_{p,P}, K_{p,I}>0 are control gains. In implementations, the second term (integral term) may correspond to the value of a memory which is iteratively incremented with a current value of the difference p(t)−p* multiplied by a step length Δt.

Further, the P, PI and PID regulators may be modified to include a hysteresis behavior. Further still, the controller 140 may further be configured to determine the control signal u as a function of the observed output paint pressure p using other regulator principles, such as linear-quadratic regulator (LQR), model-predictive control (MPC) or gain scheduling.

The feedback system including the paint supply line 120, the pressurizing means 130 and the controller 140 has a finite response time with respect to the observed output paint pressure p. The response time may be expressed as a time constant T>0 indicating the time it takes for the pressure p to reach the setpoint value p* after a positive or negative unit step perturbation. A unit step perturbation may in this context correspond to a transition from a fully closed state of the paint nozzle 110 to a fully open state.

The time constant T is negligible in an ideal feedback system, whereas in practice the time constant has a finite nonzero value. FIG. 6 illustrates, in line with the inventors' observations, that a non-zero value of the time constant T may produce artefacts in the image to be printed. In this figure, the arrow 310 indicates a local direction of the image sweep pattern. In the image 300 to be printed, a blank area to the left of area 601 is followed by a sharply delimited nominally black area, which is in turn followed by another blank area. To achieve this, the paint-nozzle control signal w has a waveform corresponding to one period of a square wave, i.e., the paint nozzle 110 is to be fully open (100%) while it passes over the black area and then close again (0%). The paint flow dV/dt however will not raise to the maximum flow (100%) until after the time T, meaning that the area 601 will be incompletely covered with paint. As suggested by the drawing, the area 601 will thus have a greyish appearance or it may contain stripes and other defects.

Another consequence of the nonzero response time can sometimes be observed after the printing of the black area has ended. Indeed, when the paint nozzle 110 suddenly closes while the pressurizing means 130 is active, the paint supply line 120 may suffer from a temporary excess pressure. The excess pressure could at worst—depending on the condition of the paint nozzle 110—cause disturbing leakage of droplets of paint onto the surface 170 in the nominally blank area at the right-hand side of the image 300.

It is noted that the feedback system may respond to a negative pressure perturbation (e.g., paint nozzle 110 opening) in accordance with a first time constant and it may respond to a positive pressure perturbation (e.g., paint nozzle 110 closing) in accordance with a second time constant different from the first one.

In FIG. 8, the arrow 310 indicates a local direction of an image sweep pattern that is used for printing an image 300. Here, for the reasons just explained each of the edges 801 is a risk of visible transients due to the slow response time of the feedback system made up of the paint supply line 120, the pressurizing means 130 and the controller 140. More precisely, the nominally painted leading edges 801 (on the left-hand side of each shaded image block) are at risk of incomplete coverage due to insufficient pressure, and the nominally blank trailing edges 801 (on the right-hand side of each shaded image block) are at risk of being stained with leaking paint unless the components of the paint nozzle 110 are able to withstand the pressure build-up in the paint supply line 120.

Paint-Pressure Control with Feedforward

In accordance with the first aspect, some of the inventors' proposed improvements to the painting system 100 will be discussed next. Generally speaking, it is proposed to configure the controller 140 in such manner that the control law further includes a feedforward component in addition to the feedback component. The feedforward component is dependent on image data in a next-to-be-printed region (or lookahead area) 320 of the user-defined image 300. For example, the feedforward component may be dependent on a predicted paint consumption V₃₂₀ in the next-to-be-printed region 320, which consumption may be computed from the image data in said region. For example, the paint consumption may be predicted by summing the pixel values (of each basic color) over the region 320. Alternatively, for a printhead with a plurality of controllable nozzles 114, the paint consumption may be predicted as the number—or average number—of nozzles that will be active (firing) during the passage of the printhead through the region 320. The feedforward component may cause a positive or negative modification of the control signal u in proportion to the predicted paint consumption, as will be discussed in detail below. The inventors have realized that controlling the pressurizing means in response to a feedforward signal which indicates the predicted paint consumption V₃₂₀ may ensure smooth operation and/or advantageous painting performance.

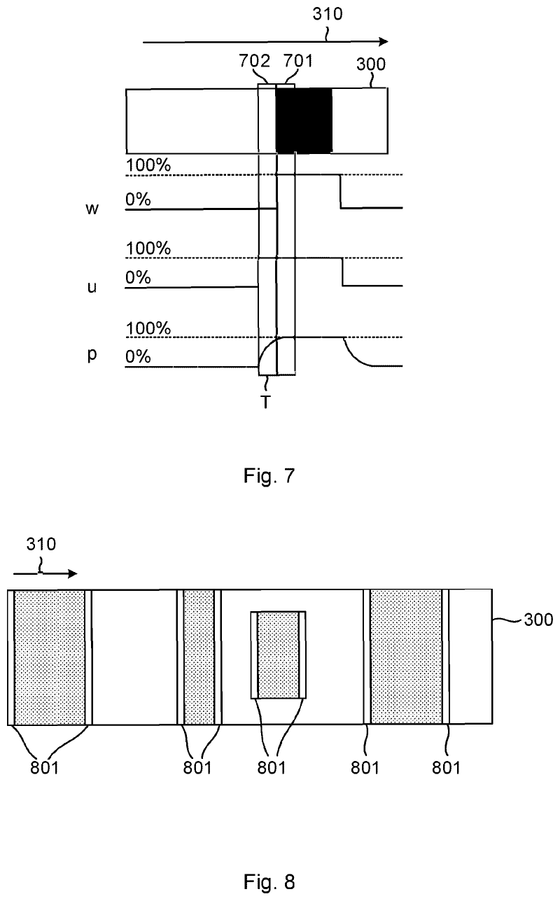

To illustrate, FIG. 7 shows a user-defined image 300 with a high-density portion shown in solid black color, and a local image sweep direction 310. The lower portion of FIG. 7 contains corresponding plots (as a function of the sweep 310) of a control signal w to the paint nozzle, a control signal u to the pressurizing means generated according to embodiments herein, and a resulting output paint pressure p. The pressure buildup is accomplished during the phase 702, whose duration is approximately equal to the time constant T, so that the subsequent area 701 is completely covered. This is an improvement over the greyish appearance of the area 601 in FIG. 6. There is no precautionary pressure reduction before the trailing edge of the high-density area in the example shown in FIG. 7, although this may be provided in some embodiments disclosed herein.

The extent of the region 320 next to be printed can be deduced from the image sweep pattern 310. Example next-to-be-printed regions 320 are shown in FIGS. 3A, 3B and 4. The region 320 is generally delimited by lateral boundaries 321 which are locally parallel to the image sweep pattern 310, and by a leading boundary 322 corresponding to a leading shape of the paint nozzle 110, which is curved in FIGS. 3A and 3B and straight in FIG. 4. The width of the region 320 is approximately equal to the effective printing width e. The length of the region 320 is denoted L. Preferably, for the purpose of defining the feedforward component, the next-to-be-printed region 320 is one which will be completed during the next T′ units of time, where T′ is greater than or equal to the time constant T (or response time) of the feedback system made up of the paint supply line 120, the pressurizing means 130 and the controller 140. Accordingly, when the paint nozzle 110 moves along the image sweep pattern 310 at speed vₙ, the length is approximately given by

$$L = {\int }_{0}^{{T}^{′}} {v}_{n} ( t ) dt ,$$

which simplifies into L=vₙT′ if the speed vₙ is constant.

Letting u_{FB} denote the feedback component defined above, u_{FF} denote the feedforward component, and V₃₂₀ denote the predicted paint consumption in the next-to-be-printed region 320, the proposed control law may be written

$$u ( p ) = {u}_{FB} ( p ) + {u}_{FF} ( {V}_{320} ) \qquad ( 1 )$$

in such embodiments where the feedforward component u_{FF} provides an additive modification of the control signal u. FIG. 2B is a plot of the control law according to (1), wherein the maximum value u₁, which represents the peak capacity of the pressurizing means 130, as well as the first control gain Kₚ are unchanged. For example, the feedforward component may be defined as follows:

$${u}_{F F} ( {V}_{320} ) = \{ \begin{matrix}- {u}_{0} , & {V}_{320} \leq {\overline{V}}_{320} - ε , \\ 0 , & {\overline{V}}_{320} - ε < {V}_{320} < {\overline{V}}_{320} + ε , \\ {u}_{0} , & {\overline{V}}_{320} + ε \leq {V}_{320}\end{matrix} ,$$

where ε, u₀, V̅₃₂₀ are constants such that [V̅₃₂₀−ε, V̅₃₂₀+ε] represents a regular range of operation where normally no adjustment (or compensation) is necessary. When no adjustment is necessary, the feedforward component u_{FF}(V₃₂₀) has its neutral value 0. Alternatively, u_{FF} may vary continuously with V₃₂₀, as follows:

$${U}_{F F} ( {V}_{320} ) = {K}_{V} \times ( {V}_{320} - {\overline{V}}_{320} )$$

where K_{V}>0 is a second control gain.

In other embodiments, the feedforward component provides a multiplicative modification, such as

$$u ( p ) = {u}_{FB} ( p ) \times [ 1 + {u}_{FF} ( {V}_{320} ) ] \qquad ( 2 )$$

where the neutral value u_{FF}(v₃₂₀) is still 0. The hitherto described embodiments may be summarized such that the feedforward component provides a temporary (additive or multiplicative) increase of the feedback component if the predicted paint consumption V₃₂₀ in the region 320 exceeds an upper threshold V̅₃₂₀+ε, and/or that the feedforward component provides a temporary (additive or multiplicative) decrease of the feedback component if the predicted paint consumption V₃₂₀ is less than a lower threshold V̅₃₂₀−ε.

In another group of embodiments, the feedforward component may be integrated with the feedback component. In one embodiment, the first control gain depends on image data in the next-to-be-printed region 320, such as the predicted paint consumption V₃₂₀, that is Kₚ=Kₚ(V₃₂₀). The modified control law becomes:

$$u ( p ) = \{ \begin{matrix}{u}_{1} , & p \leq {p}_{1} , \\ {K}_{p} ( {V}_{320} ) \times ( {p}^{*} - p ) , & {p}_{1} < p < {p}^{*} , \\ 0 , & {p}^{*} \leq p\end{matrix} , \qquad ( 3 a )$$

where p₁=p*−u₁/Kₚ(V₃₂₀) like above. In other words, the feedforward component provides a temporary modification of the first control gain Kₚ such that the response (cf. FIG. 2B) is steeper or flatter depending on the predicted paint consumption V₃₂₀. One may set, for example,

$${K}_{p} ( {V}_{320} ) = \{ \begin{matrix}( 1 - α ) {\overline{K}}_{p} , & {V}_{320} \leq {\overline{V}}_{320} - ε , \\ {\overline{K}}_{p} , & {V}_{320} - ε < {V}_{320} < {V}_{320} + ε , \\ ( 1 - α ) {\overline{K}}_{p} , & {\overline{V}}_{320} - ε \leq {V}_{320}\end{matrix} , \qquad ( 3 b )$$

where ε, V̅₃₂₀ are constants such that [V̅₃₂₀−ε, V̅₃₂₀+ε] represents a regular range of operation, K̅ₚ is a default value of the first control gain and α>0. Equation (3b) provides a stepwise variation of the first control gain Kₚ. It is noted that an increase in Kₚ shifts the point p=p₁ to the right. Alternatively, one may set

$${K}_{p} ( {V}_{320} ) = \{ \begin{matrix}( 1 - α ) {\overline{K}}_{p} , & {V}_{320} \leq {\overline{V}}_{320} - ε , \\ {\overline{K}}_{p} , & {V}_{320} - ε < {V}_{320} < {V}_{320} + ε , \\ ( 1 - {α}^{′} \times ( {V}_{320} - {\overline{V}}_{320} ) ) {\overline{K}}_{p} , & {\overline{V}}_{320} + ε \leq {V}_{320}\end{matrix} . \qquad ( 3 c )$$

for some α′>0. Equation (3c) further includes, when V₃₂₀ is greater than the regular range, a locally linear contribution proportional to the deviation from V̅₃₂₀. Equation (3c) may be described as an asymmetric modification of the first control gain Kₚ. As noted above, if a static value of the first control gain Kₚ is used, that value has normally been tuned in view of a desired balance between responsiveness and stability. It may not provide a quick enough response for the case where the paint nozzle 110 transitions from a fully closed to a fully open condition, or vice versa. The present embodiment is likely to improve the performance of the feedback system at such transitions, and without disrupting the stability of the system in other operating scenarios.

In another embodiment in this group, the setpoint value p* is modified in dependence of the predicted paint consumption V₃₂₀, to provide the following modified control law:

$$u ( p ) = \{ \begin{matrix}{u}_{1} , & p \leq {p}_{1} , \\ {K}_{p} \times ( {P}^{*} ( {V}_{320} ) - p ) , & {p}_{1} < p < {p}^{*} ( {V}_{320} ) , \\ 0 , & {p}^{*} ( {V}_{320} ) \leq p\end{matrix} , \qquad ( 4 a )$$

where again p₁=p*(V₃₂₀)−u₁/Kₚ. Here, one may define the setpoint value as follows:

$${p}^{*} ( {V}_{320} ) = \{ \begin{matrix}{\overline{p}}^{*} - β , & {V}_{320} \leq {\overline{V}}_{320} - ε , \\ {\overline{p}}^{*} , & {\overline{V}}_{320} - ε < {V}_{320} < {\overline{V}}_{320} + ε , \\ {\overline{p}}^{*} + β , & {\overline{V}}_{320} + ε \leq {\overline{V}}_{320}\end{matrix} , \qquad ( 4 b )$$

where ε, V̅₃₂₀ are constants such that [V̅₃₂₀−ε, V̅₃₂₀+ε] represents a regular range of operation, p̅* is a default setpoint value and β>0 is a configurable setpoint adjustment term. By increasing or decreasing the setpoint value in anticipation of the predicted paint consumption V₃₂₀, the paint supply line 120 is placed in a condition better suited for the imminent paint work: the output pressure of the paint supply line 120 may drop momentarily when the paint nozzle 110 transitions to an open condition—as for a leading edge of a high-density area—but it only drops to a pressure level that is still sufficient to achieve full coverage of image areas with a high density of paint. A similar advantage can be achieved for trailing edges of high-density areas. Alternatively, an asymmetric modification of the setpoint value, similar to equation (3c) can be used.

The modifications according to (3) and (4) can be combined to obtain further embodiments within this group.

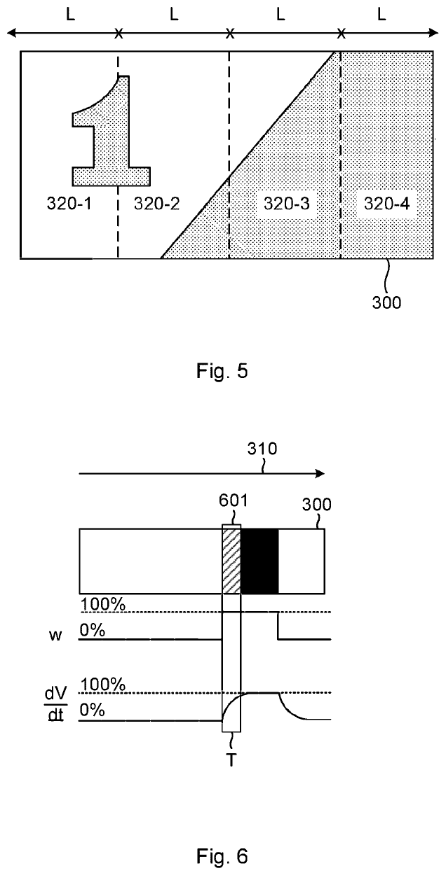

The hitherto described embodiments can be modified by using, instead of the predicted paint consumption V₃₂₀ in the next-to-be-printed region 320, a rate of change of the predicted paint consumption with respect to time. The inventors have observed for some painting systems 100 that a moderate rate of change can be adequately handled by the feedback component, whereas very fast changes could cause visible artefacts. To illustrated, reference is made to FIG. 5, which shows a user-defined image 300 annotated with successive regions 320-1, 320-2, 320-3, 320-4 to be printed at respective points in time t₁, t₂, t₃, t₄, in accordance with the image sweep pattern. One may write

$${V}_{320} ( {t}_{1} ) = {V}_{320 - 1} ,$$

$${V}_{320} ( {t}_{2} ) = {V}_{320 - 2} ,$$

$${V}_{320} ( {t}_{3} ) = {V}_{320 - 3} ,$$

$${V}_{320} ( {t}_{4} ) = {V}_{320 - 4} ,$$

and approximately define the rate of change of the predicted paint consumption as

$${V}_{320}^{′} ( {t}_{2} ) \approx {V}_{320} ( {t}_{2} ) - {V}_{320} ( {t}_{1} ) ,$$

$${V}_{320}^{′} ( {t}_{3} ) \approx {V}_{320} ( {t}_{3} ) - {V}_{320} ( {t}_{2} ) ,$$

$${V}_{320}^{′} ( {t}_{4} ) \approx {V}_{320} ( {t}_{4} ) - {V}_{320} ( {t}_{3} ) .$$

Thus, the above control laws can be modified by replacing conditions such as V₃₂₀≤V̅₃₂₀−ε or V₃₂₀≥V̅₃₂₀+ε with |V₃₂₀′(t)|≥ε′, where ε′ represents an irregularly high rate of change of the predicted paint consumption. The adjustment (or compensation) will then be triggered by the rate of change rather than the values as such.

Some embodiments specifically target painting systems 100 where the controller 140 is configured to generate the feedback component of the control signal using a PI or PID regulator. As explained above, the integral term in such regulators may be represented by a memory I(tₙ) which is iteratively incremented with a current value of the difference p−p* multiplied by a step length Δt, as follows:

$$I ( {t}_{n + 1} ) = I ( {t}_{n} ) + ( p ( {t}_{n} ) - {p}^{*} ) \times Δ t . \qquad ( 5 )$$

According to these embodiments, the feedforward component provides a modification of the integral term which is dependent on the image data in the next-to-be-printed region 320. The modification will be a temporary modification since the iterative increments (5) will continue in the subsequent time steps. For example, the feedforward component may correspond to an additive modification γ(V₃₂₀(tₙ)) of the integral term which depends on the predicted paint consumption V₃₂₀(tₙ) at time tₙ:

$$I ( {t}_{n + 1} ) = I ( {t}_{n} ) + ( p ( {t}_{n} ) - {p}^{*} ) \times Δ t + γ ( {V}_{320} ( {t}_{n} ) ) . \qquad ( 6 )$$

Alternatively, the value of the integral term will be replaced in its entirety, as follows:

$$I ( {t}_{n + 1} ) = γ ( {V}_{320} ( {t}_{n} ) ) , \qquad ( 7 )$$

wherein the contribution from the previous value I(tₙ) and/or the increment term (p(tₙ)−p*)×Δt is discarded. Similar to the above-described embodiments, one may define the additive modification along the following lines:

$$γ ( {V}_{320} ) = \{ \begin{matrix}- {γ}_{0} , & {V}_{320} \leq {\overline{V}}_{320} - ε , \\ 0 , & {\overline{V}}_{320} - ε < {V}_{320} < {\overline{V}}_{320} + ε , \\ {γ}_{0} , & {\overline{V}}_{320} + ε \leq {V}_{320}\end{matrix} ,$$

where ε, γ₀, V̅₃₂₀ are positive constants such that [V̅₃₂₀−ε, V̅₃₂₀+ε] represents a regular range of operation where normally no adjustment is necessary. The value of γ₀ may be tuned experimentally for representative scenarios. When no adjustment is necessary, γ(V₃₂₀) has its neutral value 0. Another option is to include the additive modification as a function of the rate of change of the predicted paint consumption. Further still, the integral term may be modified multiplicatively:

$$I ( {t}_{n + 1} ) = I ( {t}_{n} ) \times [ 1 + γ ( {V}_{320} ( {t}_{n} ) ) ] , \qquad ( 8 a )$$

$$or$$

$$I ( {t}_{n} ) ← I ( {t}_{n} ) \times [ 1 + γ ( {V}_{320} ( {t}_{n} ) ) ] , \qquad ( 8 b )$$

where ← denotes assignment. This will tend to trigger a relatively stronger or a relatively weaker response from the feedback component, depending on the sign of γ(V₃₂₀).

### Method for Printing an Image

In accordance with the second aspect of this disclosure, the following method may be used for the purpose of printing a user-defined image 300 onto a surface 170. The method may be executed in a painting system 100 of the type depicted in FIG. 1. In the painting system 100, at least the controller 140 may be directly involved in the execution of the method. Further technical means, such as the paint nozzle 110 and the arm 111 may be indirectly involved, e.g., they are activated by the two controllers 140, 180. The robot controller 180 may be active in parallel to the further controller 140 during the execution of the method.

In the method, paint is dispensed from a paint nozzle 110 while the paint nozzle 110 is being moved over the surface 170, e.g. by the arm 111. During the dispensing, the movements of the paint nozzle 110 are in accordance with an image sweep pattern 310 suitable for the user-defined image 300. As explained above, the image sweep pattern 310 may be a static pattern or a pattern dynamically adapted to the surface 170 and/or the image 300. During the dispensing, further, an output paint pressure p of the paint supply line 120 is sensed, and a flow of paint is fed into the paint supply line 120 so as to maintain an output paint pressure p of the paint supply line 120 at a setpoint value p*. The paint may be fed into the paint supply line 120 using one of the above-described pressurization means 130, such as a valve that can be opened towards a reservoir maintained at a pressure above the setpoint value p* (e.g., paint tank 150), or using a pump or compressor. The output paint pressure p of the paint supply line 120 may be maintained at the setpoint value p* using any of the feedback principles outlined above, including P, PI or PID feedback control.

The method according to the second aspect further includes determining an adjustment to be applied to said flow of paint. The adjustment is determined based on image data from an image region 320 next to be printed. The image region 320 next to be printed may be derived from the image sweep pattern, possibly in view of the width e of the paint nozzle 110. The region 320 may correspond to a subset of the user-defined image 300 which is to be printed during the next T units of time, where T is a predetermined duration.

The adjustment may correspond to the modifications discussed above with reference to equation (1), (2), (3), (4), (6), (7) or (8).

In specific embodiments of the method, the adjustment is determined on the basis of a predicted paint consumption V₃₂₀ in the region 320 of the user-defined image 300.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A painting system, comprising:
a paint nozzle adapted to dispense paint onto a surface;
an arm configured to move the paint nozzle over the surface in accordance with an image sweep pattern;
a pressurizing device operable to feed paint into a paint supply line that extends up to the paint nozzle; and
a controller arranged to control the pressurizing device and configured with a control law that includes a feedback component for maintaining an output paint pressure of the paint supply line at a setpoint value;
wherein the control law further comprises a feedforward component dependent on image data in a region of a user-defined image, which region is next to be printed according to the image sweep pattern.

2. The painting system of claim 1, wherein the feedforward component is dependent on a predicted paint consumption in the region of the user-defined image.

3. The painting system of claim 2, wherein the feedforward component provides a temporary increase of the feedback component if the predicted paint consumption in the region exceeds an upper threshold.

4. The painting system of claim 2, wherein the feedforward component provides a temporary decrease of the feedback component when the predicted paint consumption in the region is less than a lower threshold.

5. The painting system of claim 1, wherein the region corresponds to a subset of the user-defined image that is to be printed during the next T units of time, where T is predetermined.

6. The painting system of claim 5, wherein the feedforward component is dependent on a rate of change of the predicted paint consumption with respect to time.

7. The painting system of claim 1, wherein the controller is arranged to control the pressurizing device by applying a numeric control signal that includes the feedback component and the feedforward component.

8. The painting system of claim 7, wherein the feedforward component provides a temporary additive modification of the feedback component.

9. The painting system of claim 8, wherein the feedback component of the control signal is locally related to a deviation of the output paint pressure from the setpoint value by a predetermined control gain.

10. The painting system of claim 9, wherein the feedforward component provides a temporary modification of the control gain.

11. The painting system of claim 10, wherein the controller includes a proportional-integral (PI) regulator or a proportional-integral-derivative (PID) regulator arranged to generate the feedback component of the control signal; and wherein the feedforward component provides a temporary modification of an integral term in the PI or PID regulator.

12. The painting system of claim 1, wherein the pressurizing device comprises at least one of:
a pump,
a compressor, and
a valve connected to a pressurized reservoir.

13. A method of printing a user-defined image onto a surface, comprising:
dispensing paint from a paint nozzle while the paint nozzle is moved over the surface in accordance with an image sweep pattern;
sensing an output paint pressure of a paint supply line that extends up to the paint nozzle;
feeding a flow of paint into the paint supply line to maintain an output paint pressure of the paint supply line at a setpoint value; and
determining, from image data in a region of the user-defined image, which region is next to be printed according to the image sweep pattern, an adjustment to be applied to said flow of paint.

14. The method of claim 13, wherein the adjustment is determined based on a predicted paint consumption in the region of the user-defined image.

15. The method of claim 13, wherein the region corresponds to a subset of the user-defined image that is to be printed during the next T units of time, where T is predetermined.

16. A computer program comprising instructions stored in a memory that, when executed by a controller, cause the controller to execute a method of printing a user-defined image onto a surface, comprising:
instructions for dispensing paint from a paint nozzle while the paint nozzle is moved over the surface in accordance with an image sweep pattern;
instructions for sensing an output paint pressure of a paint supply line that extends up to the paint nozzle;
instructions for feeding a flow of paint into the paint supply line to maintain an output paint pressure of the paint supply line at a setpoint value; and
instructions for determining, from image data in a region of the user-defined image, which region is next to be printed according to the image sweep pattern, an adjustment to be applied to said flow of paint.
